(19) United States
(12) Patent Application Publication
(10) Pub. No.: US 2006/0184929 A1
(43) Pub. Date: Aug. 17, 2006

(54) Replacement part and image forming apparatus

(75) Inventor: Yoshinori Ohtsuka, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/349,989

(22) Filed: Feb. 9, 2006

(30) Foreign Application Priority Data
Feb. 16, 2005 (JP) 2005-039828

(51) Int. Cl. G06F 9/44

(52) U.S. Cl. 717/168

(57) ABSTRACT

An image forming apparatus includes a developing unit, which is detachably installed in the image forming apparatus, and a setting storage section, which stores firmware. The developing unit includes an IC tag for storing an update program for updating the firmware of the image forming apparatus. The image forming apparatus includes a detection section for detecting that the developing unit is installed in the image forming apparatus, a program acquisition section for acquiring the update program from the IC tag, and an update program execution section for executing the update program so as to perform a writing function of updating the firmware. This makes it possible to provide an image forming apparatus, which does not receive data from outside via a communication device, but which allows automatic version upgrading of the firmware serving as software for operating the image forming apparatus.

This Nonprovisional application claims priority under 35 U.S.C. §119(a) on Patent Application No. 039828/2005 filed in Japan on Feb. 16, 2005, the entire contents of which are hereby incorporated by reference.

### FIELD OF THE INVENTION

The present invention relates to (i) a replacement part (e.g., a toner cartridge, a developing cartridge, and a process cartridge) to be detachably installed in the main body of an image forming apparatus (e.g., a copier, a facsimile, and a printer) and (ii) an image forming apparatus in which the replacement part is installed.

### BACKGROUND OF THE INVENTION

Conventionally, an image forming apparatus such as a printer carries out image recording as follows. First, the conventional image forming apparatus forms a latent image by selectively exposing a photosensitive drum (image carrier) uniformly charged. Next, the latent image is visualized, with toner serving as a developer, so as to become a toner image. Then, the toner image is transferred onto a recording medium.

In such a conventional image forming apparatus, the toner needs to be refilled every time the toner runs out. The toner refill not only causes trouble, but also sometime leaves a stain. Further, only a specialized service person can carry out the maintenance of components of the image forming apparatus. These problems often cause inconvenience for a user.

In light of this, the following cartridge-type image forming apparatus has been practically used. In the main body of the apparatus, a process cartridge including a developing device and the like in one piece is detachably installed. With this, the user is allowed to replace the process cartridge when the toner runs out or when a part (e.g., developing roller) is worn out. Accordingly, the maintenance is facilitated.

Such a cartridge-type image forming apparatus requires the user to replace the process cartridge. Therefore, the cartridge-type image forming apparatus needs to be provided with a device (means) for notifying the user of (i) the shortage of the toner or (ii) the worn-out of the part (e.g., developing roller).

In light of this, there has been proposed such a method that: a calculated use amount of the cartridge is stored in a nonvolatile storage device (storage means) (e.g., EEPROM) which is provided in the main body of the apparatus, and which serves as a detection section (detection means) for detecting the end of the part's life and an amount of consumed toner. For example, there has been known an image forming apparatus including means for additionally storing, when the photosensitive drum is exposed to a laser beam or the like, information about exposure time, i.e., information corresponding to a remaining amount of toner.

Further, for example, Japanese Unexamined Patent Publication 198146/1998 (Tokukaihei 10-198146; published on Jul. 31, 1998) (Patent Document 1) and Japanese Unexamined Patent Publication 39783/2003 (Tokukai 2003-39783; published on Feb. 13, 2003) (Patent Document 2) disclose such an arrangement that the cartridge includes an IC chip storing information regarding the cartridge. With this, when the cartridge is newly installed in the main body of the apparatus, the user is notified of the information regarding the cartridge.

In Patent Documents 1 and 2, the IC chip stores product information such as a toner type, an amount of consumed toner, a product name, a manufacturer's name, and a distributor's name.

Further, Japanese Unexamined Patent Publication 126008/1999 (Tokukaihei 11-126008; published on May 11, 1999) (Patent Document 3) discloses an arrangement that manages recycling of a toner cartridge by storing, in an IC chip, lot numbers of components (e.g., developing roller, photoreceptor cleaning blade) of the toner cartridge, the number of times of recycling of the toner cartridge, and the cumulative number of paper sheets printed by the toner cartridge.

In such a conventionally proposed structure, the IC chip attached to the toner cartridge merely stores information.

Incidentally, a recent image forming apparatus realizes, e.g., a copy machine by installing an image reading device in a printer, and performs, e.g., a facsimile function by adding a communication device (communication means) to the copy machine. More specifically, in recent years, there has been widely used a digital complex machine to which new functions can be added in addition to the copy function by using various units installed in the digital complex machine.

However, for example, when a paper sheet ejection device is newly installed in a copy machine, firmware serving as software for operating the copy machine needs to be updated so that the copy machine in which the paper sheet ejection device is newly installed operates properly. Moreover, the firmware needs to be updated by the service person who carries out the maintenance of the copy machine.

In light of this, for example, Japanese Unexamined Patent Publication 316066/2000 (Tokukai 2000-316066; published on Nov. 14, 2000) (Patent Document 4) discloses a method for saving the user from the trouble of asking the service person to upgrade the firmware.

Specifically, according to the method disclosed in Patent Document 4, the firmware of the printer is updated by receiving data from outside via a communications line with the use of the facsimile function.

However, according to the foregoing conventional arrangement, the data for upgrading the firmware needs to be obtained via the communication device. Therefore, a printer or a copy machine having no communication device cannot obtain the data, for example. Such a printer or a copy machine has such a problem that the firmware cannot be automatically upgraded.

### SUMMARY OF THE INVENTION

The present invention has as an object to provide: (i) an image forming apparatus, which does not receive data from outside via a communication device, but which allows version upgrading of firmware serving as software for operating the image forming apparatus; and (ii) a replacement part to be installed in the image forming apparatus.

In order to attain the foregoing object, a replacement part of the present invention includes a storage device for storing an update program for updating firmware of an image forming apparatus, the replacement part being detachably installed in the image forming apparatus.

In the foregoing arrangement, the replacement part refers to a part that is installed, in order to be used, in the image forming apparatus by which the functions of the replacement part are exhibited, and that is detached from the image forming apparatus so as to be replaced due to either (i) deterioration of a container of the part, or (ii) consumption, deterioration, or the like of a consumable item which is contained in the container and which is intended to be consumed by operation of the image forming apparatus.

Further, in the foregoing arrangement, the firmware is software for operating the image forming apparatus. Specific examples of the firmware include software such as (i) BIOS or OS for carrying out basic control of hardware and (ii) application software for carrying out image formation. Further, the description “updating [the] firmware” means (1) a change (update) of an execution code of the firmware, (2) a change of data indicative of parameters of the firmware, and (3) a change of both the execution code and the data indicative of the parameters.

According to the foregoing arrangement, the firmware can be updated simply by installing the replacement part in the image forming apparatus. This makes it unnecessary to acquire data via a communications line as has been conventionally done. Further, since the firmware can be updated simply by installing the replacement part in the image forming apparatus, the firmware can be easily updated (upgraded), for example, even in the absence of a service person.

In order to attain the foregoing object, an image forming apparatus of the present invention is an image forming apparatus for carrying out an image forming operation, the image forming apparatus, including: a replacement part, which is detachably installed in the image forming apparatus, and which includes a storage device for storing an update program for updating firmware of the image forming apparatus; a storage section for storing the firmware; an acquisition section (acquisition means) for acquiring the update program from the storage device; and an update program execution section (update program execution means) for executing the update program so as to perform a writing function of updating the firmware.

According to the foregoing arrangement, by acquiring and executing the update program stored in the storage device of the replacement part, the firmware of the image forming apparatus can be updated (upgraded). With this, no communication device needs to be provided, but the firmware can be updated more easily as compared with the conventional arrangement which updates the firmware with the use of data acquired from outside via the communication device. That is, the foregoing arrangement makes it possible to update the firmware of the image forming apparatus simply by installing the replacement part.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram schematically illustrating an arrangement of an image forming apparatus.

FIG. 2 is a side perspective view schematically illustrating an arrangement of an image forming apparatus according to an embodiment of the present invention.

FIG. 3 is a side perspective view of the image forming apparatus in which a toner cartridge is installed.

FIG. 4 is a perspective view schematically illustrating an arrangement of a developing unit.

FIG. 5 is a perspective view schematically illustrating the arrangement of the developing unit.

FIGS. 6(a) and 6(b) are data tables illustrating information stored in an IC tag.

FIG. 7 is a flowchart illustrating an update process of updating firmware.

### DESCRIPTION OF THE EMBODIMENTS

One embodiment of the present invention will be described below. An image forming apparatus according to the present embodiment reads out, from a storage device provided in a replacement part such as a developing unit, an update program for updating software (firmware) for operating the image forming apparatus, and executes the update program so as to update the firmware. Further, the replacement part according to the present embodiment includes the storage device storing the update program.

Although the following description assumes that the replacement part is the developing unit (also referred to as “developing cartridge”) which includes a toner bottle (toner cartridge) containing toner to be supplied, the replacement part is not limited to this. The replacement part refers to a part which constitutes a part of an apparatus in terms of function, and which can recover or retain the performance of the apparatus by way of replacement. In the case of the image forming apparatus, for example, the replacement part corresponds to (i) a toner cartridge, (ii) a developing cartridge, (iii) a photosensitive cartridge, (iv) a cartridge that includes a developing member and a photoreceptor in one piece, (v) an ink cartridge, (vi) a cartridge that includes an ink tank and a print head in one piece, (vii) a thermal-transfer ink sheet cartridge, or the like. In the industry to which the present invention pertains, these products are sometimes called “supplies”.

Further, the following description assumes that the firmware is the software for operating the image forming apparatus. Specific examples of the firmware include software (e.g., BIOS or OS) that carries out basic control of hardware. Further, the description “updating [the] firmware” refers to (1) change (update) of an execution code of the firmware, (2) change of data indicative of parameters of the firmware, and (3) change of both the execution code and the data indicative of the parameters.

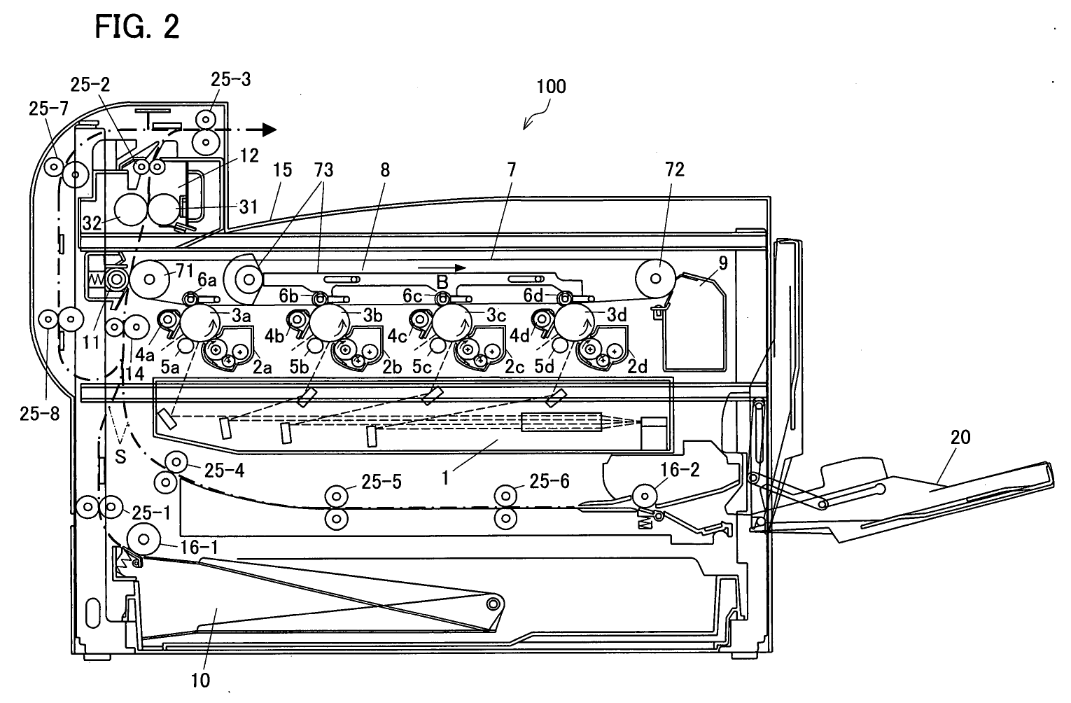

First, an arrangement of an image forming apparatus 100 will be schematically described. The following describes one embodiment of the present invention with reference to FIG. 2.

FIG. 2 is a side perspective view schematically illustrating the image forming apparatus 100 according to the present embodiment.

The image forming apparatus 100 forms, in accordance with image data received from outside, a monochrome or multicolor image on a predetermined sheet (recording paper sheet). As illustrated in FIG. 2, the image forming apparatus 100 includes an exposure unit 1, developing devices 2 (2a, 2b, 2c, 2d), photosensitive drums 3 (3a, 3b, 3c, 3d), chargers 5 (5a, 5b, 5c, 5d), cleaner units 4 (4a, 4b, 4c, 4d), an intermediate transfer belt unit 8, a fixing section 12, a paper sheet transportation path S, a paper sheet feeding section 10, a paper sheet ejection section 15, and the like.

The image data to be processed in the image forming apparatus 100 corresponds to a color image made up of four colors: black (K), cyan (C), magenta (M), and yellow (Y). Accordingly, the image forming apparatus 100 is provided with four image stations. The four image stations form four types of latent image corresponding to the four colors, respectively. An image station corresponding to black (K) includes the developing device 2a, the photosensitive drum 3a, the charger 5a, and the cleaner unit 4a. An image station corresponding to cyan (C) includes the developing device 2b, the photosensitive drum 3b, the charger 5b, and the cleaner unit 4b. The image station corresponding to magenta (M) includes the developing device 2c, the photosensitive drum 3c, the charger 5c, and the cleaner unit 4c. The image station corresponding to yellow (Y) includes the developing device 2d, the photosensitive drum 3d, the charger 5d, and the cleaner unit 4d.

The photosensitive drums 3 are provided (installed) in an upper portion of the image forming apparatus 100. The photosensitive drums 3 rotate in a predetermined direction. The chargers 5 serve as charging means for uniformly charging surfaces of the photosensitive drums 3 at predetermined potentials, respectively. See FIG. 2. Each of the chargers 5 may be, e.g., a contact-roller-type charger, a brush-type charger, and a discharge-type charger. As illustrated in FIG. 2, the exposure unit 1 may be a laser scanning unit (LSU) including a laser irradiation section and a reflective mirror. Alternatively, the exposure unit 1 may be an EL or LED writing head including light-emitting elements arranged in an array manner. Moreover, the exposure unit 1 has a function of exposing the electrified photosensitive drums 3 in accordance with the input image data. With this, electrostatic latent images are respectively formed on the surfaces of the photosensitive drums 3 in accordance with the image data. The developing devices 2 visualize, with four types of toner (black (K), cyan (C), magenta (M), yellow (Y)), the electrostatic latent images formed on the photosensitive drums 3, respectively. After the image is developed and transferred, some toner remaining on the respective surfaces of the photosensitive drums 3 is removed and collected by the cleaner units 4.

The intermediate transfer belt unit 8 provided above the photosensitive drums 3 includes an intermediate transfer belt 7, an intermediate transfer belt driving roller 71, an intermediate transfer belt tension mechanism 73, an intermediate transfer belt driven roller 72, intermediate transfer rollers 6 (6a, 6b, 6c, 6d), and an intermediate transfer belt cleaning unit 9.

The intermediate transfer belt 7 is stretched and provided on and across the intermediate transfer belt driving roller 71, the intermediate transfer belt tension mechanism 73, the intermediate transfer rollers 6, the intermediate transfer belt driven roller 72, and the like, and is also driven to rotate in the direction indicated by an arrow B of FIG. 2.

The intermediate transfer rollers 6 are rotatably supported in intermediate transfer roller installation parts of the intermediate transfer belt tension mechanism 73 of the intermediate transfer belt unit 8, respectively. The intermediate transfer rollers 6 give transfer bias for transferring respective toner images of the photosensitive drums 3 onto the intermediate transfer belt 7.

The intermediate transfer belt 7 is provided so as to make contact with each of the photosensitive drums 3. The toner images which respectively have the four colors and which are formed respectively on the photosensitive drums 3 are transferred onto the intermediate transfer belt 7 so as to be sequentially superimposed on one another. With this, a color toner image (multicolor toner image) is formed on the intermediate transfer belt 7. The intermediate transfer belt 7 is made of a film having a thickness of approximately 100 μm to 150 μm, and has no ends.

The transfer of the toner images from the photosensitive drums 3 onto the intermediate transfer belt 7 is carried out by the intermediate transfer rollers 6 making contact with a back side of the intermediate transfer belt 7. To each of the intermediate transfer rollers 6, a high-voltage transfer bias (high voltage whose polarity (+) is reverse to the charging polarity (−) of the toner) is applied for the purpose of transferring the toner images. The intermediate transfer roller 6 has, as its base, a metal (e.g., stainless-steel) shaft having a diameter of 8 mm to 10 mm. The intermediate transfer roller 6 has a surface covered with an electrically-conductive elastic material (e.g., EPDM and urethane form). Such an electrically-conductive elastic material enables the intermediate transfer roller 6 to apply the high voltage uniformly to the intermediate transfer belt 7. The intermediate transfer roller 6 employs a roller-type transfer electrode in the present embodiment, but may employ a brush-type transfer electrode instead.

The electrostatic latent images which are formed respectively on the photosensitive drums 3 and which are visualized respectively in accordance with the colors are superimposed on the intermediate transfer belt 7 so as to become the image information sent to the apparatus. The image information thus obtained by the superimposition is sent, by the rotation of the intermediate transfer belt 7, to a position where a below-mentioned sheet (recording paper sheet) comes into contact with the intermediate transfer belt 7. Then, the image information is transferred onto the sheet by a transfer roller 11 provided in the position.

In this case, the intermediate transfer belt 7 and the transfer roller 11 are pressed against each other so that a predetermined nip is formed between the intermediate transfer belt 7 and the transfer roller 11. To the transfer roller 11, the voltage (high voltage whose polarity (+) is reverse to the charging polarity (−) of the toner) for transferring the toner to the recording paper sheet is applied. Furthermore, while either one of the transfer roller 11 and the intermediate transfer belt driving roller 71 is made of a hard material (e.g., metal), the other is made of a soft material (e.g., elastic rubber or resin foam). With this, the nip can be constantly obtained.

Further, as described above, the toner adheres to the intermediate transfer belt 7 as the result of the contact of the intermediate transfer belt 7 with the photosensitive drums 3, or the toner is not transferred onto the sheet by the transfer roller 11 and accordingly remains on the intermediate transfer belt 7. Such toner causes a mixture of the colors of toner in the next step. Therefore, the toner is removed and collected by the intermediate transfer belt cleaning unit 9. The intermediate transfer belt cleaning unit 9 includes, e.g., a cleaning member which makes contact with the intermediate transfer belt 7. Examples of the cleaning member include a cleaning blade. The intermediate transfer belt 7 making contact with the cleaning blade is supported by the intermediate transfer belt driven roller 72 so that the back side of the intermediate transfer belt 7 makes contact with the intermediate transfer belt driven roller 72.

The paper sheet feeding section 10 serves as a tray for storing sheets used for image formation. The paper sheet feeding section 10 is provided below the image forming section and the exposure unit 1 of the image forming apparatus 100. Further, the paper sheet ejection section 15 serves as a tray for loading printed sheets in a face-down manner, i.e., in such a manner that printed sides of the sheets face down. The paper sheet ejection section 15 is provided in an upper portion of the image forming apparatus 100.

Further, the image forming apparatus 100 is provided with the paper sheet transportation path S for sending the sheets from the paper sheet feeding section 10 to the paper sheet ejection section 15 via the transfer roller 11 and the fixing section 12. The paper sheet transportation path S extends substantially vertically. Furthermore, provided near the paper sheet transportation path S extending from the paper sheet feeding section 10 to the paper sheet ejection section 15 are a pickup roller 16-1, a resist roller 14, the transfer roller 11, the fixing section 12, and transportation rollers 25 (25-1, 25-2, 25-3) for transporting the sheets.

Each of the transportation rollers 25 is a small roller for facilitating/assisting the transportation of the sheets. The transportation rollers 25 are provided along the paper sheet transportation path S. The pickup roller 16-1 is a feeding roller provided on one end of the paper sheet feeding section 10 so as to supply the sheets one by one to the paper sheet transportation path S.

Further, the resist roller 14 temporarily suspends the transportation of each of the sheets through the paper sheet transportation path S. At such a timing that the head of the sheet is aligned with the head of each of the toner images on the photosensitive drums 3, the resist roller 14 transports the sheet to a transfer section.

The fixing section 12 includes a heat roller 31 and a pressure roller 32. The heat roller 31 and the pressure roller 32 rotate with the sheet sandwiched therebetween.

Further, the heat roller 31 is controlled by a control section in accordance with a signal from a temperature detector (not shown), so as to be set at a predetermined fixing temperature. Moreover, the sheet between the heat roller 31 and the pressure roller 32 is subjected to heat and pressure. This causes melting and mixing of the multicolor toner image, transferred onto the sheet, with the result that the multicolor toner image is pressed and fixed by heat on the sheet.

The paper sheet having the multicolor toner image fixed thereon is transported by the transportation rollers 25 to a reverse paper sheet ejection path of the paper sheet transportation path S, and then is ejected onto the paper sheet ejection section 15 in a reversed manner (i.e., in such a manner that the multicolor toner image faces down).

The following explains in detail the sheet transportation path S. The image forming apparatus 100 is provided with not only the paper sheet feeding section 10 for preliminarily storing the sheets, but also a manual paper sheet feeding tray 20 allowing for printing of a small number of sheets.

The pickup roller 16-1 is provided in the paper sheet feeding section 10, specifically, in the side positioned in the sheet transporting direction, so as to feed the sheets one by one to the paper sheet transportation path S. On the other hand, a pickup roller 16-2 is provided in the manual paper sheet feeding tray 20, specifically, in the side positioned in the sheet transporting direction, so as to feed the sheets one by one to the paper sheet transportation path S.

Each of the sheets transported from the paper sheet feeding section 10 is transported to the resist roller 14 by a transportation roller 25-1 provided in the paper sheet transportation path S. At such a timing that the head of the sheet is aligned with the head of the image information on the intermediate transfer belt 7, the sheet is transported to the transfer roller 11 so that the image information is written on (transferred onto) the sheet. Thereafter, the sheet is brought to the fixing section 12 so that the toner yet to be fixed on the sheet is melted and fixed by heat on the sheet. The sheet is ejected from a transportation roller 25-3, serving also as a paper sheet ejection roller, to the paper sheet ejection section 15 via a transportation roller 25-2. Note that this is a case of single-side printing.

On the other hand, each of the sheets loaded on the manual paper sheet feeding tray 20 is fed by the pickup roller 16-2, and then reaches the resist roller 14 via a plurality of transportation rollers (25-6, 25-5, 25-4). Thereafter, the sheet is ejected to the paper sheet ejection section 15 after being subjected to the same process as the sheet fed from the paper sheet feeding section 10. Note that this is the case of single-side printing.

On the other hand, see a case where double-side printing is required on this occasion. After the sheet subjected to the single-side printing passes through the fixing section 12, the back end of the sheet is clamped by the transportation roller 25-3. The transportation roller 25-3 rotates in a reverse direction so as to guide the sheet to transportation rollers (25-7, 25-8). Thereafter, the sheet is subjected to back-side printing after passing through the resist roller 14, and then is ejected to the paper sheet ejection section 15.

In the present embodiment, developing units 40 (replacement parts) are detachably installed in the image forming apparatus 100. Each of the developing units 40 includes (i) each of the developing devices 2 for supplying the toner to the image forming apparatus 100 and (ii) a toner cartridge 60 for containing the toner.

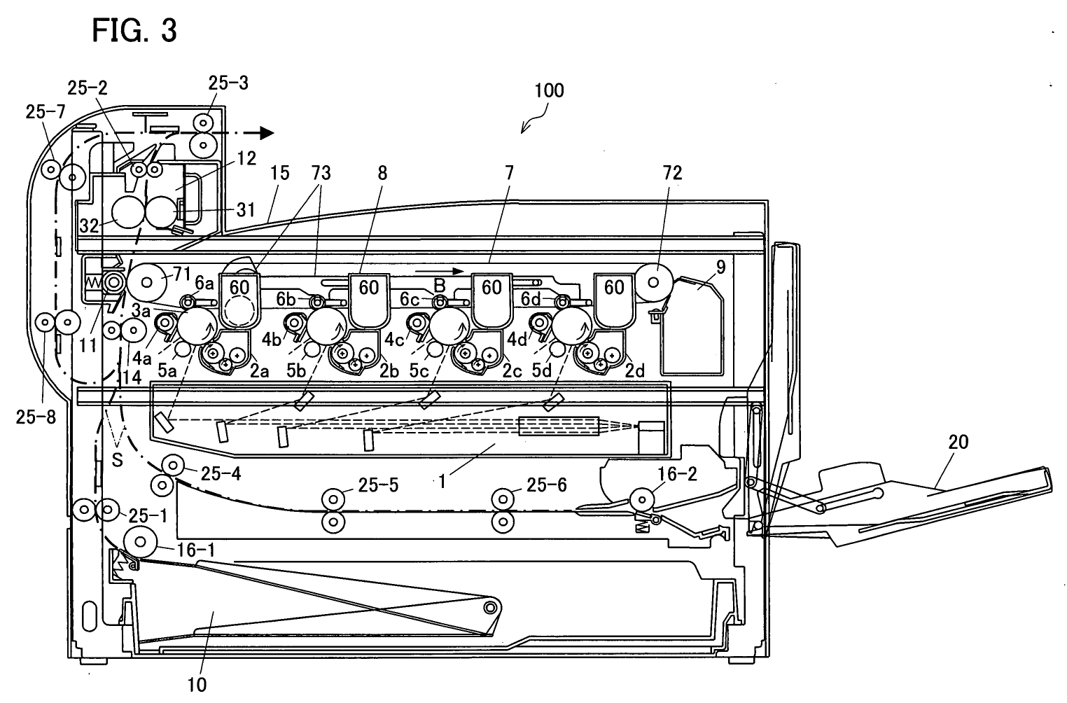

The toner cartridge 60 of the developing unit 40 is also detachably installed in the developing device 2. That is, the toner cartridge 60 is also detachably installed in the image forming apparatus 100. Moreover, as illustrated in FIG. 3, the toner cartridge 60 is installed in the developing device 2. Note that FIG. 3 is a side perspective view of the image forming apparatus 100 in which the toner cartridge 60 is installed. The developing unit 40 including the toner cartridge 60 and the developing device 2 will be described later.

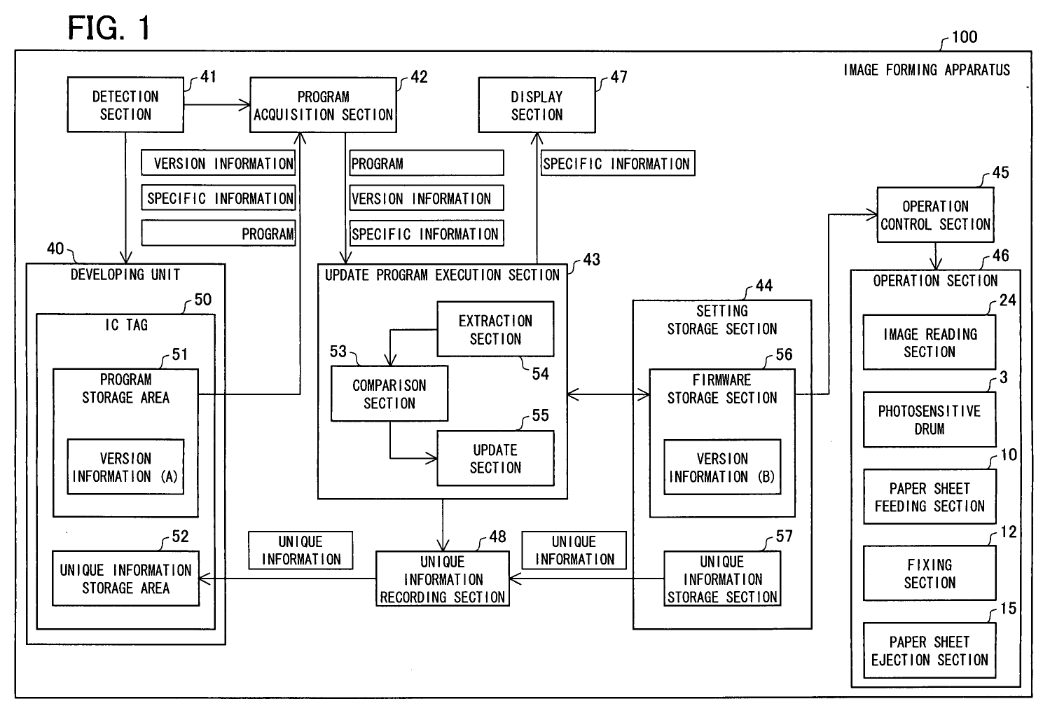

FIG. 1 is a block diagram schematically illustrating an arrangement of the image forming apparatus 100. The following explains an arrangement for executing an update program acquired from a storage device (IC tag 50) provided in a toner bottle serving as a replacement part.

As illustrated in FIG. 1, the image forming apparatus 100 includes a detection section 41, a program acquisition section 42, an update program execution section 43, a setting storage section 44, an operation control section 45, an operation section 46, a display section 47, a unique information recording section 48, and the developing unit 40.

The developing unit 40 supplies the toner to the image forming section of the main body of the image forming apparatus 100, and visualizes, with the toner, each of the electrostatic latent images formed respectively on the photosensitive drums 3. Moreover, in the developing unit 40, the developing device 2 and the toner cartridge 60 containing the toner are in one piece. Note that the developing unit 40 will be described later.

The detection section 41 detects whether or not the developing unit 40 serving as the replacement part is installed in the image forming apparatus 100. Specific examples of the detection section 41 include a mechanical switch and an infrared sensor.

The program acquisition section 42 acquires, from the IC tag 50 (storage device) of the developing unit 40, the update program for updating the firmware of the image forming apparatus 100. In addition to the update program, in the present embodiment, the program acquisition section 42 acquires, from the IC tag 50, (i) version information of the update program and (ii) specific information for specifying the update program.

The update program execution section 43 executes the update program acquired by the program acquisition section 42. More specifically, the update program execution section 43 executes the update program so that the firmware stored in the setting storage section 44 is rewritten (updated). Examples of the update program execution section 43 include a calculation processing device such as a CPU. The detailed arrangement of the update program execution section 43 will be described later.

The display section 47 displays the specific information for specifying the update program. The display section 47 displays not only the specific information but also various types of information. Moreover, the display section 47 includes (i) a display panel (not shown) such as a liquid crystal panel or an organic EL panel and (ii) a driving circuit of the display panel.

The setting storage section 44 at least stores the firmware. In the present embodiment, the setting storage section 44 includes a firmware storage section 56 and a unique information storage section 57. The firmware storage section 56 stores the firmware. Further, the firmware storage section 56 stores version information (B) of the firmware. Further, the unique information storage section 57 stores apparatus unique information for specifying the image forming apparatus 100. More specifically, the unique information storage section 57 stores the apparatus unique information such as a serial number individually given to the image forming apparatus 100. Further, in addition to the apparatus unique information, the unique information storage section 57 may store various types of information such as a model number of the image forming apparatus 100 and detailed information about the units installed in the image forming apparatus 100.

The operation control section 45 carries out control of an operation of the operation section 46 described later. More specifically, the operation control section 45 controls the operation of the operation section 46 in accordance with the firmware stored in the firmware storage section 56.

The operation section 46 actually operates for the image formation. Specifically, the operation section 46 includes an image reading section 24, the photosensitive drums 3, the paper sheet feeding section 10, the fixing section 12, and the paper sheet ejection section 15. The operation control section 45 controls an operation of each of these components. The image reading section 24 optically reads a document image. In accordance with the image information read by the image reading section 24, the electrostatic latent images are formed respectively on the photosensitive drums 3. The paper sheet feeding section 10 supplies, to the photosensitive drums 3, the sheet to be subjected to the image formation. The fixing section 12 fixes the toner image formed on the sheet by the developing unit 40. The paper sheet ejection section 15 ejects the sheet subjected to the image formation. The operation section 46 includes not only those components described above, but also any component whose operation is controlled by the operation control section 45.

The unique information recording section 48 records, in a unique information storage area 52 of the IC tag 50 of the developing unit 40, the apparatus unique information stored in the unique information storage section 57 of the setting storage section 44. More specifically, in the present embodiment, the unique information recording section 48 stores the apparatus unique information in the unique information storage area 52 when the unique information recording section 48 receives, from the update program execution section 43, a completion report notifying that the updating of the firmware is completed.

The following explains the detailed arrangement of the update program execution section 43. The update program execution section 43 includes an extraction section 54, a comparison section 53, and an update section 55.

The extraction section 54 acquires the version information (A) of the update program and the version information (B) of the current firmware. More specifically, the extraction section 54 extracts (acquires) the version information (B) from the firmware storage section 56 of the setting storage section 44, and acquires the version information (A) of the update program acquired by the program acquisition section 42. In cases where the update program and the version information (A) are integrated, the extraction section 54 extracts the version information (A) from the update program.

The comparison section 53 makes a comparison between the version information (A) and the version information (B) which are extracted by the extraction section 54. Then, the comparison section 53 judges which version information is newer. More specifically, the comparison section 53 makes a comparison between respective version numbers of the version information (A) and the version information (B) so as to judge which version information is newer.

The update section 55 rewrites the firmware when the comparison section 53 judges that the version information (A) of the update program is newer than the version information (B) of the firmware.

Thus, the update program execution section 43 performs such a writing function of updating the firmware by executing the update program.

The following explains the developing unit 40.

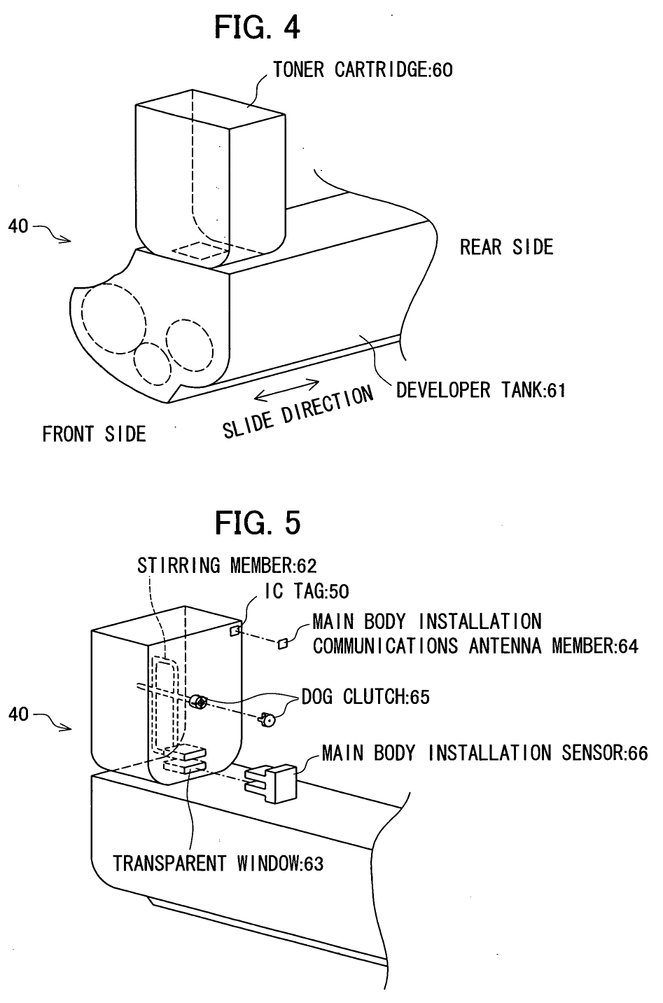

FIGS. 4 and 5 are perspective views schematically illustrating an arrangement of the developing unit 40. As illustrated in FIG. 4, the developing unit 40 includes a developer tank 61 and the toner cartridge 60. Moreover, the developing unit 40 is detachably installed in the image forming apparatus 100.

The developer tank 61 forms a toner image in accordance with the electrostatic latent image with the use of the toner supplied from the toner cartridge 60.

The toner cartridge 60 contains the toner serving as a developer. As illustrated in FIG. 5, the toner cartridge 60 includes a stirring member 62, the IC tag 50, and a transparent window 63. The stirring member 62 stirs the toner contained in the toner cartridge 60. When the developing unit 40 is installed in the image forming apparatus 100, a dog clutch 65 attached to a rotation shaft of the stirring member 62 engages with a dog clutch 65 provided in the image forming apparatus 100. Moreover, the stirring member 62 is rotated by the dog clutch 65 connected to a driving source (not shown) provided in the image forming apparatus 100. The transparent window 63 is provided so that a main body installation sensor 66 serving as the detection section 41 provided in the image forming apparatus 100 detects whether or not the developing unit 40 is installed. More specifically, the main body installation sensor 66 and the transparent window 63 engage with each other.

The IC tag 50 stores the firmware. More specifically, the IC tag 50 includes a program storage area 51 and the unique information storage area 52. The program storage area 51 stores the update program for updating the firmware. Moreover, the information (firmware) stored in the IC tag 50 is read by a main body installation communications antenna member 64 serving as the program acquisition section 42 provided in the image forming apparatus 100. That is, in the present embodiment, the information stored in the IC tag 50 provided in the developing unit 40 is read by the image forming apparatus 100 in a non-contact manner. The following explains the information which includes the firmware and which is stored in the IC tag 50.

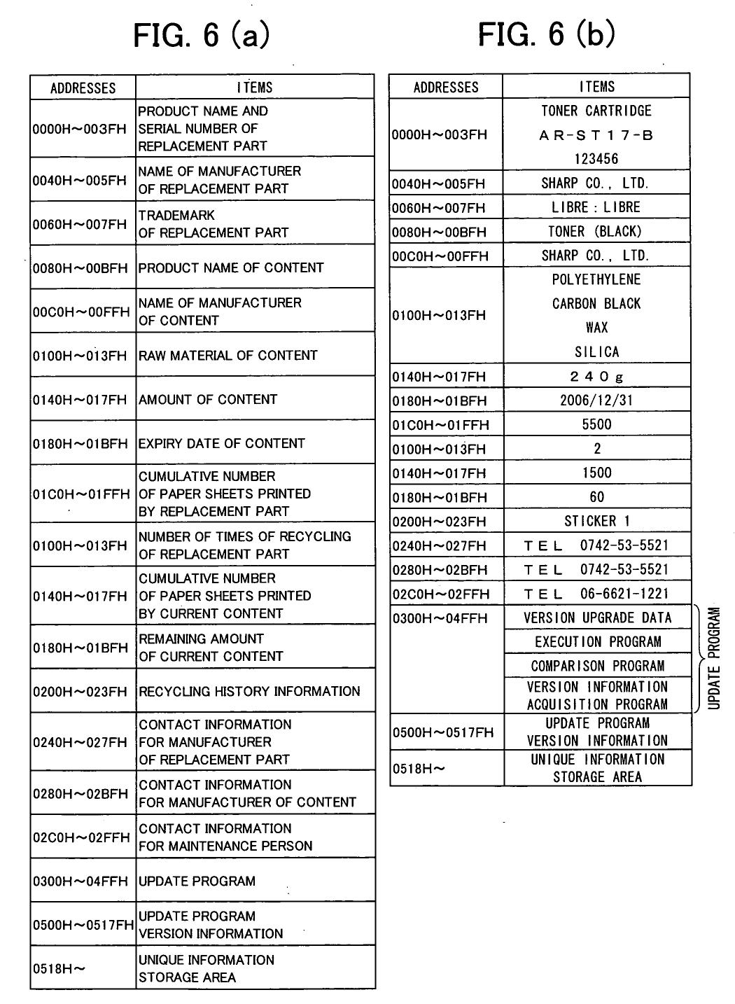

FIGS. 6(a) and 6(b) are data tables illustrating the information stored in the IC tag 50. FIG. 6(a) shows the information stored in the IC tag 50. FIG. 6(b) shows specific examples of the information.

As shown in each of FIGS. 6, the IC tag 50 stores the update program for updating the firmware. In the present embodiment, the IC tag 50 stores (i) the update program, (ii) the version information of the update program, and (iii) the specific information for specifying the update program.

More specifically, as shown in FIG. 6(a), the IC tag 50 stores (1) a product name of the replacement part, (2) a serial number of the replacement part, (3) a name of a manufacturer of the replacement part, (4) a trademark of the update program, (5) a product name of a content, (6) a name of a manufacturer of the content, (7) a raw material of the content, (8) an amount of the content, (9) an expiry date of the content, (10) the cumulative number of paper sheets printed by the replacement part, (11) the number of times of recycling of the replacement part, (12) the cumulative numbers of paper sheet printed by the current content, (13) a remaining amount of the current content, (14) recycling history information, (15) contact information for the manufacturer of the replacement part, (16) contact information for the manufacturer of the content, (17) contact information for maintenance, and (18) the update program.

For example, as shown in FIG. 6(b), in cases where the replacement part is the developing unit 40, the IC tag 50 stores (1) “Toner Cartridge AR-ST17-B” as the “product name of the replacement part”, (2) “0000123456” as the “serial number of the replacement part”, (3) “Sharp Co., Ltd.” as the “name of the manufacturer of the replacement part”, (4) “LIBRE” as the “trademark of the update program”, (5) “Toner (black)” as the “product name of the content”, (6) “Sharp Co., Ltd.” as the “name of the manufacturer of the content”, (7) “polyethylene, carbon black, wax, silica” as the “raw material of the content”, (8) “240 g” as the “amount of the content”, (9) “Dec. 31, 2006” as the “expiry date of the content”, (10) “5500” as the “cumulative number of paper sheets printed by the replacement part”, (11) “2” as the number of times of recycling of the replacement part”, (12) “1500” as the “cumulative number of paper sheets printed by the current content”, (13) “60” as the “remaining amount of the current content”, (14) “Sticker 1” as the “recycling history information”, (15) “TEL 0742-53-5521” as the “contact information for the manufacturer of the replacement part”, (16) “TEL 0742-53-5521” as the “contact information for the manufacturer of the content, (17) “TEL 06-6621-1221” as the “contact information for the maintenance”, and (18) “Version Upgrade Data, Execution Program, Comparison Program, and Version Information Acquisition Program” as the “update program”.

Among these, the “trademark of the update program” corresponds to the specific information for specifying the update program. Therefore, in the present embodiment, when the update program is executed in the image forming apparatus 100 in which the developing unit 40 is installed, the display section 47 displays “LIBRE” serving as the “trademark of the update program” stored in the IC tag 50.

Further, as shown in FIGS. 6(a) and 6(b), the IC tag 50 has the unique information storage area 52. The unique information storage area 52 is an area in which the unique information recording section 48 of the image forming apparatus 100 writes the information unique to the image forming apparatus 100.

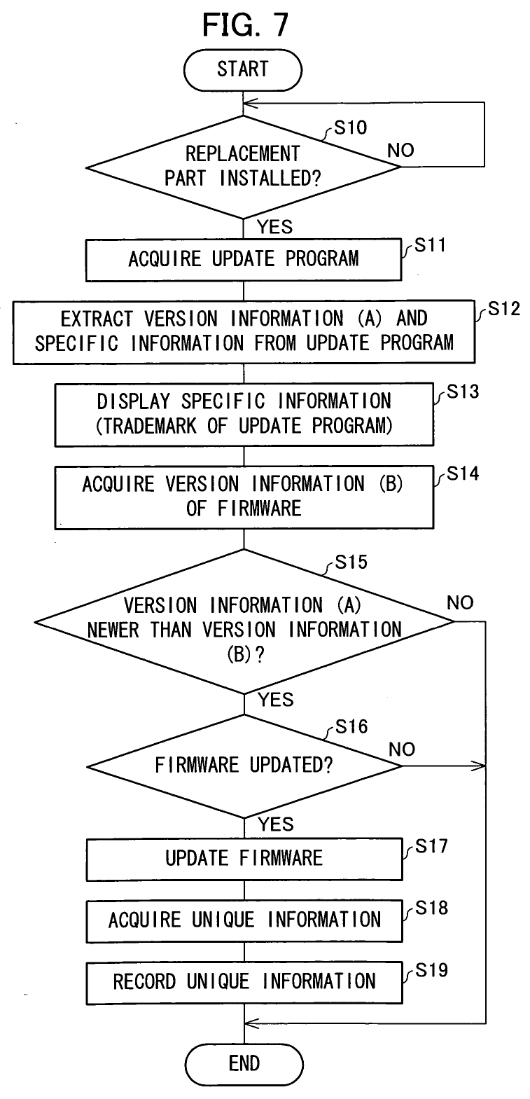

FIG. 7 is a flowchart illustrating an update process for updating the firmware. The following explains, with reference to FIG. 7, such an update process that: when the developing unit 40 is installed in the image forming apparatus 100, the firmware is updated by the update program which is stored in the IC tag 50 of the developing unit 40 and which is read out by the image forming apparatus 100.

First, the detection section 41 of the image forming apparatus 100 detects whether or not the developing unit 40 is installed in the image forming apparatus 100 (S10). When the detection section 41 detects, in the step S10, that the developing unit 40 is installed (YES in S10), the detection section 41 transmits, to the program acquisition section 42, a data acquisition command that instructs the program acquisition section 42 to read out data stored in the IC tag 50 of the developing unit 40.

When the program acquisition section 42 receives the data acquisition command, the program acquisition section 42 acquires the data which includes the update program and which is stored in the IC tag 50 of the developing unit 40 (S11). In the present embodiment, the program acquisition section 42 acquires the update program, the version information (A) of the update program, and the specific information (“trademark of the update program” in this case) for specifying the update program.

Next, the program acquisition section 42 transmits, to the update program execution section 43, the data acquired from the IC tag 50. When the update program execution section 43 acquires the data including the update program, the update program execution section 43 executes the update program thus acquired. Specifically, the update program execution section 43 performs respective functions of the extraction section 54, the comparison section 53, and the update section 55 by executing the update program. This allows the firmware to be updated.

Specifically, the update program execution section 43 transmits, to the display section 47, the trademark of the update program and information regarding the update program. The trademark and the information are included in the data acquired from the program acquisition section 42. The trademark serves as the specific information for specifying the update program. The display section 47 displays, on the display panel, the received trademark of the update program and the received information regarding the update program (S13).

Next, the extraction section 54 of the update program execution section 43 extracts the version information (B) of the current firmware stored in the setting storage section 44. Moreover, the extraction section 54 transmits, to the comparison section 53, the version information (B) and the version information (A) which is acquired from the program acquisition section 42.

Moreover, the comparison section 53 makes a comparison between the version information (A) and the version information (B) so as to judge whether or not the version information (A) of the update program is newer than the version information (B) of the firmware (S15).

When the comparison section 53 judges, in the step S15, that the version information (A) is newer than the version information (B) (YES in S15), the comparison section 53 notifies the update section 55 that the version information (A) is newer than the version information (B).

When the update section 55 is notified that the version information (A) is newer than the version information (B), the update section 55 causes the display section 47 to display information for asking an operator of the image forming apparatus 100 whether or not the firmware is updated (S16).

In accordance with the information displayed by the display section 47 in the step S16, the operator of the image forming apparatus 100 decides whether or not the firmware is updated. Moreover, the operator uses a manipulation (operation) section (not shown) of the image forming section so as to give an instruction about whether or not the firmware is updated.

When the update section 55 receives, from the operator, an updating command for updating the firmware, the update section 55 updates the firmware stored in the setting storage section 44 (S17). Specifically, the update section 55 rewrites, in accordance with an execution code and version upgrade data which are included in the update program, an execution code and/or version upgrade data each of which is stored in the setting storage section 44 and each of which is necessary for operating the operation section 46. The version upgrade data stored in the setting storage section 44 indicates the parameters.

On completion of the updating of the firmware, the update program execution section 43 notifies the unique information recording section 48 of the completion of the updating of the firmware.

When the unique information recording section 48 is notified of the completion of the updating of the firmware, the unique information recording section 48 acquires the apparatus unique information stored in the unique information storage section 57 of the setting storage section 44 (S18). Moreover, the unique information recording section 48 records the apparatus unique information in the unique information storage area 52 of the IC tag 50 (S19).

The firmware is not updated either (i) in cases where the comparison section 53 judges, in the step S15, that the version information (A) is not newer than the version information (B), or (ii) in cases where the update section 55 is notified, in the step S16, that the firmware is not updated.

Thus, the image formation apparatus 100 acquires, from the storage device (IC tag 50) of the developing unit 40 serving as a replacement part, the update program for updating the firmware. This allows the firmware of the image forming apparatus 100 to be updated.

The following explains one example of the update program.

For example, in cases where the update program indicates changes in numeric data such as development bias and toner stirring time, numeric data (e.g., development bias and toner stirring time) stored in the firmware is overwritten in accordance with the version upgrade data of the update program so as to be modified.

Further, for example, see a case where a heavy-duty correction function is added. The heavy-duty correction function is such a function that: every time printing is carried out for ten consecutive minutes under such conditions that the humidity is 40% or higher and the printing rate per sheet exceeds 15%, a toner density reference value of the developer is increased by a heavy-duty correction value of 0.25% (upper limit 1.25%); and when the foregoing conditions are not satisfied, the heavy-duty value is decreased by a heavy-duty correction value of 0.25% (lower limit 0%) every ten minutes. In this case, a toner density control program area has no space for the correction function. Therefore, the update section 55 writes, in a free space of a ROM, a modification program allowing for the correction function. Then, the update section 55 writes, in the toner density control program area, a command of jumping to the modification program. This allows the firmware to be updated.

Further, for example, the various types of data which are stored in the IC tag 50 of the developing unit 40 may be preliminarily encrypted, and may be decrypted when the various types of data which are stored in the IC tag 50 are read out. This will be described in the following.

The IC tag 50 stores the update program for updating the firmware. The firmware is software for controlling operation of the image forming apparatus 100. When the firmware is wrongly rewritten, the image forming apparatus 100 is not likely to operate properly. That is, the image forming apparatus 100 does not operate properly when the firmware is updated by executing the update program rewritten by, e.g., a third person.

This can be avoided as follows. That is, the update program to be stored in the IC tag 50 is preliminarily encrypted with the use of a private key. The encrypted update program is decrypted with the use of a public key corresponding to the private key, when the program acquisition section 42 of the image forming apparatus 100 reads out the encrypted update program. By thus preliminarily encrypting the update program stored in the IC tag 50, the update program can be prevented from being dishonestly altered in a process of distributing the developing unit 40.

The public key (decryption key) for decrypting the encrypted update program may be stored, for example, in a main memory (e.g., the setting storage section 44) of the image forming apparatus 100 before shipment from a factory, or may be stored in the image forming apparatus 100 later by the service person.

Further, for example, the specific information for specifying the update program for updating the firmware of the image forming apparatus 100 is stored in the setting storage section 44. When the firmware is updated, the update program execution section 43 makes a comparison between (i) the specific information which specifies the update program and which is acquired from the IC tag 50 via the program acquisition section 42, and (ii) the specific information which is stored in the setting storage section 44. When the specific information (i) is different from the specific information (ii), the display section 47 may display a warning. More specifically, the trademark of the update program permitted to carry out the updating of the firmware of the image forming apparatus 100 is preliminarily stored in the setting storage section 44. The update program execution section 43 judges whether or not the trademark of the update program read out from the IC tag 50 is identical to the trademark stored in the setting storage section 44. When the update program execution section 43 judges that the trademarks are different, the display section 47 may display the warning. As such, when the IC tag 50 does not have the trademark registered in the setting storage section 44, the warning is actively given so that the user can avoid trouble.

Even when the display section 47 displays the warning, the user may allow the image formation to be carried out. In such a case, the operation control section 45 operates the operation section 46 so that the image formation is carried out.

Further, after the firmware has been updated, the update program execution section 43 may cause the setting storage section 44 to store the specific information which specifies the developing unit 40 and which is stored in the IC tag 50 of the developing unit 40. Specifically, the specific information such as a serial number individually given to the developing unit 40 is stored in the IC tag 50. When the firmware is updated with the use of the update program stored in the IC tag 50, the specific information stored in the IC tag 50 is caused to be stored in the setting storage section 44. This makes it possible to create a history of the developing unit 40 having been installed in the image forming apparatus 100. Accordingly, for example, even when the image forming apparatus 100 does not operate properly by updating the firmware with the use of an inferior non-genuine developing unit, the cause of the improper operation can be identified by checking back the history.

As described above, a developing unit 40 according to the present invention includes an IC tag 50 for storing an update program for updating firmware of an image forming apparatus 100, the developing unit 40 being detachably installed in the image forming apparatus 100.

In the foregoing arrangement, the developing unit 40 refers to a part that is installed, in order to be used, in the image forming apparatus 100 by which the functions of the developing unit 40 are exhibited, and that is detached from the image forming apparatus 100 so as to be replaced due to either (i) deterioration of a container of the part, or (ii) consumption, deterioration, or the like of a consumable item which is contained in the container and which is intended to be consumed by operation of the image forming apparatus 100.

Further, in the foregoing arrangement, the firmware is software for operating the image forming apparatus 100. Specific examples of the firmware include software such as (i) BIOS or OS for carrying out basic control of hardware and (ii) application software for carrying out image formation. Further, the description “updating [the] firmware” means (1) a change (update) of an execution code of the firmware, (2) a change of data indicative of parameters of the firmware, and (3) a change of both the execution code and the data indicative of the parameters.

According to the foregoing arrangement, the firmware can be updated simply by installing the developing unit 40 in the image forming apparatus 100. This makes it unnecessary to acquire data via a communications line as has been conventionally done. Further, since the firmware can be updated simply by installing the developing unit 40 in the image forming apparatus 100, the firmware can be easily updated (upgraded), for example, even in the absence of a service person.

In addition to the foregoing arrangement, the developing unit 40 according to the present invention is more preferably arranged such that: the update program is read out by the image forming apparatus 100, and causes the image forming apparatus 100 to perform an updating function of updating the firmware.

The foregoing arrangement makes it possible to update the firmware of the image forming apparatus 100 with the use of the update program read out from the IC tag 50. Therefore, the firmware of the image forming apparatus 100 can be updated simply by installing the developing unit 40 in the image forming apparatus 100.

In addition to the foregoing arrangement, the developing unit 40 according to the present invention is more preferably arranged such that the update program causes the image forming apparatus 100 to perform: an acquisition function of acquiring version information of the firmware; a comparison function of making a comparison between (i) version information of the update program, and (ii) the version information of the firmware which version information is stored in the image forming apparatus 100 in which the developing unit 40 is installed; and an updating function of updating the firmware when the version information of the update program is judged to be newer than the version information of the firmware.

According to the foregoing arrangement, the comparison is carried out between the version information of the current firmware and the version information of the update program before the update of the firmware of the image forming apparatus 100. The firmware is updated only when the version information of the update program is newer than the version information of the firmware. This makes it possible to prevent the firmware having the newest version information from being rewritten by the update program having older version information.

In addition to the foregoing arrangement, the developing unit 40 according to the present invention is more preferably arranged such that: the update program further causes a display section 47 of the image forming apparatus 100 to perform a display function of displaying specific information that specifies the update program.

Since the forgoing arrangement makes it possible to display specific information that specifies the update program for updating the firmware of the image forming apparatus 100, it can be understood what the update program is like. Further, confirmation of the specific information allows the user of the image forming apparatus 100 to judge whether or not the update program is normal (qualified) one.

In addition to the foregoing arrangement, the developing unit 40 according to the present invention is more preferably arranged such that: the IC tag 50 includes a unique information storage area 52 for storing apparatus unique information that is stored in the image forming apparatus 100 in which the developing unit 40 is installed, and that is individually given to the image forming apparatus 100.

According to the foregoing arrangement, the IC tag 50 of the developing unit 40 includes the unique information storage area 52 for storing the apparatus unique information of the image forming apparatus 100 in which the developing unit 40 is installed. This makes it possible to store the apparatus unique information of the image forming apparatus 100 whose firmware has been updated with the use of the update program stored in the IC tag 50 of the developing unit 40. Therefore, for example, the apparatus unique information read out from the developing unit 40 collected by a supplier of the developing unit 40 makes it possible to specify the image forming apparatus 100 whose firmware has been updated.

An image forming apparatus 100 according to the present invention is an image forming apparatus 100 for carrying out an image forming operation, the image forming apparatus 100, including: a developing unit 40, which is detachably installed in the image forming apparatus 100, and which includes an IC tag 50 for storing an update program for updating firmware of the image forming apparatus 100; a setting storage section 44 for storing the firmware; a program acquisition section 42 for acquiring the update program from the IC tag 50; and an update program execution section 43 for executing the update program so as to perform a writing function of updating the firmware.

According to the foregoing arrangement, by acquiring and executing the update program stored in the IC tag 50 of the developing unit 40, the firmware of the image forming apparatus 100 can be updated (upgraded). With this, no communication device needs to be provided, but the firmware can be updated more easily as compared with the conventional arrangement which updates the firmware with the use of data acquired from outside via the communication device. That is, the foregoing arrangement makes it possible to update the firmware of the image forming apparatus 100 simply by installing the developing unit 40.

In addition to the foregoing arrangement, it is more preferable that the image forming apparatus 100 according to the present invention further includes: a display section 47 for displaying specific information that specifies the update program thus acquired.

Since the foregoing arrangement makes it possible to display the specific information that specifies the update program for updating the firmware of the image forming apparatus 100, it can be understood what the update program is like. Further, confirmation of the specific information allows the user of the image forming apparatus 100 to judge whether or not the update program is normal (qualified) one.

See examples of a method for displaying the specific information. In cases where the specific information to be displayed by the display section 47 is stored in the developing unit 40, the image forming apparatus 100 may display the specific information read out from the developing unit 40. Further, in cases where the specific information to be actually displayed by the display section 47 is preliminarily stored in the image forming apparatus 100 and a designation command for designating the specific information to be displayed is stored in the developing unit 40, the image forming apparatus 100 may display, in accordance with the designation command read out from the developing unit 40, the specific information stored in the image forming apparatus 100.

In addition to the foregoing arrangement, the image forming apparatus 100 according to the present invention is more preferably arranged such that: the setting storage section 44 stores permission information for specifying an update program permitted to carry out updating of the firmware; and the update program execution section 43 makes a judgment about whether or not the permission information includes specific information that specifies the update program acquired from the IC tag 50 of the developing unit 40; and when the update program execution section 43 judges that the permission information does not include the specific information, the update program execution section 43 notifies that the permission information does not include the specific information.

With the foregoing arrangement, when the preliminarily registered permission information does not match the specific information of the update program thus acquired, the user is notified that the permission information does not match the specific information. This allows the user to cancel the updating of the firmware.

In addition to the foregoing arrangement, the image forming apparatus 100 according to the present invention is more preferably arranged such that: even when the update program execution section 43 judges that the permission information does not include the specific information, the update program execution section 43 permits the image forming operation.

With the foregoing arrangement, even when the update program execution section 43 judges that the permission information does not include the specific information, the updating of the firmware can be carried out. Therefore, for example, even when the developing unit 40 is a non-genuine part supplied from a second source, the image forming operation can be carried out. Accordingly, the user is free from inconvenience.

In addition to the foregoing arrangement, the image forming apparatus 100 according to the present invention is more preferably arranged such that: the IC tag 50 stores developing-unit-40-specific information individually given to the development unit 40; and in response to detection of the updating of the firmware has been carried out, the update program execution section 43 causes the setting storage section 44 to store the developing-unit-40-specific information.

According to the foregoing arrangement, after the firmware has been updated, the developing-unit-40-specific information is stored in the setting storage section 44. Therefore, even when the developing unit 40 is detached, the history of the developing unit 40 having been installed in the image forming apparatus 100 can be preserved. With this, for example, when the updating of the firmware causes the improper operation of the image forming apparatus 100, it is possible to track down a developing unit 40 storing the update program causing the improper operation of the image forming apparatus 100.

In addition to the foregoing arrangement, the image forming apparatus 100 according to the present invention is more preferably arranged such that: the update program execution section 43 acquires, from the IC tag 50, version information of the update program; the update program execution section 43 makes a comparison between (i) the version information of the update program and (ii) version information of the firmware; and when the update program execution section 43 judges that the version information of the update program is newer than the version information of the firmware, the update program execution section 43 carries out the updating of the firmware.

According to the foregoing arrangement, the comparison is carried out between the version information of the current firmware and the version information of the update program before the update of the firmware of the image forming apparatus 100. The firmware is updated only when the version information of the update program is newer than the version information of the firmware. This makes it possible to prevent the firmware having the newest version information from being rewritten by the update program having older version information.

In addition to the foregoing arrangement, it is more preferable that the image forming apparatus 100 according to the present invention further includes: a unique information recording section 48 for writing, in the IC tag 50 of the developing unit 40 in response to detection of the updating of the firmware, apparatus unique information individually given to the image forming apparatus 100, wherein: the setting storage section 44 stores the apparatus unique information.

According to the foregoing arrangement, the IC tag 50 of the developing unit 40 stores the apparatus unique information of the image forming apparatus 100 whose firmware has been updated. This makes it possible to store the apparatus unique information of the image forming apparatus 100 whose firmware has been updated with the use of the update program stored in the IC tag 50 of the developing unit 40. Therefore, for example, the apparatus unique information read out from the developing unit 40 collected by the supplier of the developing unit 40 makes it possible to specify the image forming apparatus 100 whose firmware has been updated.

Further, in addition to the apparatus unique information, the unique information recording section 48 may record current version information of the firmware of the image forming apparatus 100. With this, for example, even when the firmware is updated without executing the update program stored in the IC tag 50 of the developing unit 40, the apparatus unique information of the image forming apparatus 100 in which the developing unit 40 is installed is written in the IC tag 50. Therefore, the version information of the firmware of the image forming apparatus 100 in which the developing unit 40 is installed can be obtained by collecting the developing unit 40.

The above explanation assumes an example in which, when the update program is executed, the display section 47 displays “LIBRE” as the “trademark of the update program”. However, the information to be displayed in the display section 47 is not limited to this. The display section 47 may display the various types of information which are stored in the IC tag 50.

Further, the above explanation assumes an example in which the update program includes the version upgrade data, the execution program, the comparison program, and the version information acquisition program. The update program is not limited to this, but may include only the upgrade data and the execution program, for example.

Further, in the foregoing description, when the unique information recording section 48 receives, from the update program execution section 43, the completion report notifying that the updating of the firmware is completed, the unique information recording section 48 stores the apparatus unique information in the unique information storage area 52. However, even when the unique information recording section 48 does not receive the completion report, the unique information recording section 48 may store the apparatus unique information in the unique information storage area 52. That is, regardless of whether or not the firmware has been updated, the apparatus unique information may be stored in the unique information storage area 48 for the purpose of specifying the image forming apparatus 100 in which the developing unit 40 is installed. This makes it possible that a person who collects the developing unit 40 finds the image forming apparatus 100 in which the developing unit 40 is installed.

Further, the unique information recording section 48 may store, in the unique information storage area 52 of the IC tag 50, (i) the apparatus unique information, (ii) the model number of the image forming apparatus 100, and (iii) the information regarding the units installed in the image forming apparatus 100.

Further, the above arrangement deals with the case where the firmware storage section 56 stores the version information (B) of the firmware. However, the firmware and the version information may be combined or separated.

This is also true of the version information (A) of the update program. The update program and the version information (A) of the update program may be combined or separated.

Further, in the present embodiment, the update program execution section 43 includes the extraction section 54, the comparison section 53, and the update section 55. Moreover, the update program execution section 43 makes a comparison between (i) the current version information of the firmware of the image forming apparatus 100, and (ii) the version information of the acquired update program. When the update program execution section 43 judges that the firmware needs to be updated, the firmware is updated. However, the updating is not limited to this method. That is, the update program execution section 43 may not make the comparison between the version information of the firmware and the version information of the update program, but may automatically update the firmware.

See examples of a method for displaying the specific information. In cases where the specific information to be displayed by the display section 47 is stored in the IC tag 50 of the developing unit 40, the update program execution section 43 may display the specific information read out from the developing unit 40. Further, in cases where the specific information to be actually displayed by the display section 47 is preliminarily stored in the setting storage section 44 of the image forming apparatus 100 and a designation command for designating the specific information to be displayed is stored in the developing unit 40, the update program execution section 43 may display, in accordance with the designation command read out from the developing unit 40, the specific information stored in the setting storage section 44.

The developing unit 40 (replacement part) according to the present embodiment may have the IC tag 50 for storing (i) the software for upgrading the main body of the image forming apparatus 100 and (ii) the trademark of the software, and may be detachably installed in the main body of the image forming apparatus 100. This requires no maintenance, carried out by the service person or via a telephone line, for the upgrade of the image forming apparatus 100. In addition, since the trademark is stored as data, the user can check that the data is legitimate. This enables the user to avoid damage such as an act of mischief done through the developing unit 40.

Further, the image forming apparatus 100 according to the present embodiment may be arranged such that: when replacement of the developing unit 40 is detected, a trademark of version upgrade software is read out from the IC tag 50 of the developing unit 40 so as to be displayed; and after confirming permission of the user for version upgrading, the version upgrading is carried out. This makes it possible to avoid such a trouble that improper version upgrading is carried out by installing an imitated developing unit or the like.

Further, the image forming apparatus 100 according to the present embodiment may give a warning when the trademark thus read out is not registered in the main body of the image forming apparatus 100. With this, when the trademark is not registered in the main body of the image forming apparatus 100, the image forming apparatus 100 more actively gives the warning so that the user can avoid trouble. The warning may be displayed by the display section 47. Alternatively, for example, the warning may be given by way of sound or the like.

Further, the image forming apparatus 100 according to the present embodiment may be arranged such that: a normal printing operation can be carried out in response to user's permission even in cases where the read out trademark of the software is not registered in the main body of the image forming apparatus 100, or even in cases where the trademark data of the software is not stored in the developing unit 40. This makes it possible to prevent inconvenience from being posed on the user who uses the developing unit obtained from the second source.

Further, the image forming apparatus 100 according to the present embodiment may store the history of the developing units 40 replaced and installed. With this, the history can be checked back during maintenance work carried out when a failure is caused or a part's life is shortened by installing the inferior non-genuine developing unit. Collective analysis of the history makes it possible to give the warning to a wide range of users as well as the user experiencing the failure.

As described above, a replacement part according to the present invention includes a storage device for storing an update program for updating firmware of an image forming apparatus, the replacement part being detachably installed in the image forming apparatus.

In the foregoing arrangement, the replacement part refers to a part that is installed, in order to be used, in the image forming apparatus by which the functions of the replacement part are exhibited, and that is detached from the image forming apparatus so as to be replaced due to either (i) deterioration of a container of the part, or (ii) consumption, deterioration, or the like of a consumable item which is contained in the container and which is intended to be consumed by operation of the image forming apparatus.

Further, in the foregoing arrangement, the firmware is software for operating the image forming apparatus. Specific examples of the firmware include software such as (i) BIOS or OS for carrying out basic control of hardware and (ii) application software for carrying out image formation. Further, the description “updating [the] firmware” means (1) a change (update) of an execution code of the firmware, (2) a change of data indicative of parameters of the firmware, and (3) a change of both the execution code and the data indicative of the parameters.

According to the foregoing arrangement, the firmware can be updated simply by installing the replacement part in the image forming apparatus. This makes it unnecessary to acquire data via a communications line as has been conventionally done. Further, since the firmware can be updated simply by installing the replacement part in the image forming apparatus, the firmware can be easily updated (upgraded), for example, even in the absence of a service person.

In addition to the foregoing arrangement, the replacement part according to the present invention is more preferably arranged such that the update program is read out by the image forming apparatus, and causes the image forming apparatus to carry out a updating function of updating the firmware.

The foregoing arrangement makes it possible to update the firmware of the image forming apparatus with the use of the update program read out from the storage device. Therefore, the firmware of the image forming apparatus can be updated simply by installing the replacement part in the image forming apparatus.

In addition to the foregoing arrangement, the replacement part according to the present invention is more preferably arranged such that the update program causes the image forming apparatus to perform: an acquiring function of acquiring version information of the firmware; a comparing function of making a comparison between (i) version information of the update program, and (ii) the version information of the firmware stored in the image forming apparatus in which the replacement part is installed; and an updating function of updating the firmware when the version information of the update program is judged to be newer than the version information of the firmware.

According to the foregoing arrangement, the comparison is carried out between the version information of the current firmware and the version information of the update program before the update of the firmware of the image forming apparatus is updated. The firmware is updated only when the version information of the update program is newer than the version information of the firmware. This makes it possible to prevent the firmware having the newest version information from being rewritten by the update program having older version information.

In addition to the foregoing arrangement, the replacement part according to the present invention is more preferably arranged such that the update program further causes a display device (display means) of the image forming apparatus to perform a display function of displaying specific information that specifies the update program.

Since the forgoing arrangement makes it possible to display specific information that specifies the update program for updating the firmware of the image forming apparatus, it can be understood what the update program is like. Further, confirmation of the specific information allows the user of the image forming apparatus to judge whether or not the update program is normal (qualified) one.

In addition to the foregoing arrangement, the replacement part according to the present invention is arranged such that the storage device includes a storage area for storing apparatus unique information that is stored in the image forming apparatus in which the replacement part is installed, and that is individually given to the image forming apparatus.

According to the foregoing arrangement, the storage device of the replacement part includes the storage area for storing the apparatus unique information of the image forming apparatus in which the replacement part is installed. This makes it possible to store the apparatus unique information of the image forming apparatus whose firmware has been updated with the use of the update program stored in the storage device of the replacement part. Therefore, for example, the apparatus unique information read out from the replacement part collected by a supplier of the replacement part makes it possible to specify the image forming apparatus whose firmware has been updated.

An image forming apparatus according to the present invention is an image forming apparatus for carrying out an image forming operation, the image forming apparatus, including: a replacement part, which is detachably installed in the image forming apparatus, and which includes a storage device for storing an update program for updating firmware of the image forming apparatus; a storage section for storing the firmware; an acquisition section (acquisition means) for acquiring the update program from the storage device; and an update program execution section (update program execution means) for executing the update program so as to perform a writing function of updating the firmware.

According to the foregoing arrangement, by acquiring and executing the update program stored in the storage device of the replacement part, the firmware of the image forming apparatus can be updated (upgraded). With this, no communication device needs to be provided, but the firmware can be updated more easily as compared with the conventional arrangement which updates the firmware with the use of data acquired from outside via the communication device. That is, the foregoing arrangement makes it possible to update the firmware of the image forming apparatus simply by installing the replacement part.

In addition to the foregoing arrangement, it is more preferable that the image forming apparatus further includes: a display device for displaying specific information that specifies the update program thus acquired.

Since the foregoing arrangement makes it possible to display the specific information that specifies the update program for updating the firmware of the image forming apparatus, it can be understood what the update program is like. Further, confirmation of the specific information allows the user of the image forming apparatus to judge whether or not the update program is normal (qualified) one.

See examples of a method for displaying the specific information. In cases where the specific information to be displayed by the display device is stored in the replacement part, the image forming apparatus may display the specific information read out from the replacement part. Further, in cases where the specific information to be actually displayed by the display device is preliminarily stored in the image forming apparatus and a designation command for designating the specific information to be displayed is stored in the replacement part, the image forming apparatus may display, in accordance with the designation command read out from the replacement part, the specific information stored in the image forming apparatus.

In addition to the foregoing arrangement, the image forming apparatus is more preferably arranged such that: the storage section stores permission information for specifying the update program permitted to carry out updating of the firmware; and the update program execution section makes a judgment about whether or not the permission information includes specific information that specifies the update program acquired from the storage device of the replacement part; and when the update program execution section judges that the permission information does not include the specific information, the update program execution section notifies that the permission information does not include the specific information.

With the foregoing arrangement, when the preliminarily registered permission information does not match the specific information of the update program thus acquired, the user is notified that the permission information does not match the specific information. This allows the user to cancel the updating of the firmware.

In addition to the foregoing arrangement, the image forming apparatus according to the present invention is more preferably arranged such that the update program execution section controls the image forming operation in accordance with the judgment about whether or not the permission information includes the specific information.

According to the foregoing arrangement, the image forming operation is controlled in accordance with the judgment about whether or not the permission information includes the specific information.

Specifically, for example, the image forming operation may be carried out even when it is judged that the permission information does not include the specific information. With this, for example, the image forming operation is carried out even when the update program execution section judges that the permission information does not include the specific information. This makes it possible to carry out the image forming operation even when using a non-genuine replacement part obtained from a second source.

Further, for example, the user instructs the image forming operation even when it is judged that the permission information does not include the specific information. In this case, the image forming operation may be carried out while a warning is given. This enables the user to understand that the replacement part installed in the image forming apparatus is not a genuine part.

In addition to the foregoing arrangement, the image forming apparatus according to the present invention is more preferably arranged such that: the storage device stores replacement part specific information individually given to the replacement part; and in response to detection of the updating of the firmware, the update program execution section causes the storage section to store the replacement part specific information.

According to the foregoing arrangement, after the firmware has been updated, the replacement part specific information is stored in the storage section. Therefore, even when the replacement part is detached, the history of the replacement part having been installed in the image forming apparatus can be preserved. With this, for example, when the updating of the firmware causes the improper operation of the image forming apparatus, it is possible to track down a replacement part storing the update program causing the improper operation of the image forming apparatus.

In addition to the foregoing arrangement, the image forming apparatus according to the present invention is more preferably arranged such that: the update program execution section acquires, from the storage device, version information of the update program; and the update program execution section makes a comparison between (i) the version information of the update program and (ii) version information of the firmware; and when the update program execution section judges that the version information of the update program is newer than the version information of the firmware, the update program execution section carries out the updating of the firmware.

According to the foregoing arrangement, the comparison is carried out between the version information of the current firmware and the version information of the update program before the firmware of the image forming apparatus is updated, and the firmware is updated only when the version information of the update program is newer than the version information of the firmware. This makes it possible to prevent the firmware having the newest version information from being rewritten by the update program having older version information.

In addition to the foregoing arrangement, it is more preferable that the image forming apparatus according to the present invention further includes: a recording device for writing, in the storage device of the replacement part in response to detection of the updating of the firmware, apparatus unique information individually given to the image forming apparatus, wherein: the storage section stores the apparatus unique information.

According to the foregoing arrangement, the storage device of the replacement part stores the apparatus unique information of the image forming apparatus whose firmware has been updated. This makes it possible to store the apparatus unique information of the image forming apparatus whose firmware has been updated with the use of the update program stored in the storage device of the replacement part. Therefore, for example, the apparatus unique information read out from the replacement part collected by the supplier of the replacement part makes it possible to specify the image forming apparatus whose firmware has been updated.

Further, in addition to the apparatus unique information, the recording device may record current version information of the firmware of the image forming apparatus. With this, for example, even when the firmware is updated without executing the update program stored in the storage device of the replacement part, the apparatus unique information of the image forming apparatus in which the replacement part is installed is written in the storage device. Therefore, the version information of the firmware of the image forming apparatus in which the replacement part is installed can be obtained by collecting the replacement part.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A replacement part, comprising:
a storage device for storing an update program for updating firmware of an image forming apparatus,
the replacement part being detachably installed in the image forming apparatus.

2. The replacement part as set forth in claim 1, wherein the update program is read out by the image forming apparatus, and causes the image forming apparatus to perform an updating function of updating the firmware.

3. The replacement part as set forth in claim 1, wherein the update program causes the image forming apparatus to perform:
an acquiring function of acquiring version information of the firmware;
a comparing function of making a comparison between (i) version information of the update program, and (ii) the version information of the firmware stored in the image forming apparatus in which the replacement part is installed; and
an updating function of updating the firmware when the version information of the update program is judged to be newer than the version information of the firmware.

4. The replacement part as set forth in claim 1, wherein the update program further causes display means of the image forming apparatus to perform a display function of displaying specific information that specifies the update program.

5. The replacement part as set forth in claim 1, wherein the storage device includes a storage area for storing apparatus unique information that is stored in the image forming apparatus in which the replacement part is installed, and that is individually given to the image forming apparatus.

6. An image forming apparatus for carrying out an image forming operation,
the image forming apparatus, comprising:
a replacement part, which is detachably installed in the image forming apparatus, and which includes a storage device for storing an update program for updating firmware of the image forming apparatus;
a storage section for storing the firmware;
acquisition means for acquiring the update program from the storage device; and
update program execution means for executing the update program so as to perform a writing function of updating the firmware.

7. The image forming apparatus as set forth in claim 6, further comprising: display means for displaying specific information that specifies the update program thus acquired.

8. The image forming apparatus as set forth in claim 6, wherein:
the storage section stores permission information for specifying a update program permitted to carry out updating of the firmware; and
the update program execution means makes a judgment about whether or not the permission information includes specific information that specifies the update program acquired from the storage device of the replacement part; and
when the update program execution means judges that the permission information does not include the specific information, the update program execution means notifies that the permission information does not include the specific information.

9. The image forming apparatus as set forth in claim 8, wherein the update program execution means controls the image forming operation in accordance with the judgment about whether or not the permission information includes the specific information.

10. The image forming apparatus as set forth in claim 6, wherein:
the storage device stores replacement part specific information individually given to the replacement part; and
in response to detection of the updating of the firmware, the update program execution means causes the storage section to store the replacement part specific information.

11. The image forming apparatus as set forth in claim 6, wherein:
the update program execution means acquires, from the storage device, version information of the update program; and
the update program execution means makes a comparison between (i) the version information of the update program and (ii) version information of the firmware; and
when the update program execution means judges that the version information of the update program is newer than the version information of the firmware, the update program execution means carries out the updating of the firmware.

12. The image forming apparatus as set forth in claim 6, further comprising: recording means for writing, in the storage device of the replacement part in response to detection of the updating of the firmware, apparatus unique information individually given to the image forming apparatus, wherein:
the storage section stores the apparatus unique information.
